(19) United States
(12) Patent Application Publication
(10) Pub. No.: US 2026/0170544 A1
(43) Pub. Date: Jun. 18, 2026

(54) RUNOVER VERIFICATION USING A REMEDIATION TIME PREDICTION MODEL AND AN UPLIFT MODEL

(71) Applicant: Maplebear Inc., San Francisco, CA (US)

(72) Inventors: Shengwen Fang, Vancouver (CA); Michael Kurish, Perkasie, PA (US); Mengyu Zhang, Newton, MA (US); Ying Li, San Francisco, CA (US); Benjamin Knight, Oakland, CA (US); Rohit Turumella, Cupertino, CA (US); Rebecca Riso, Croton-On-Hudson, NY (US)

(21) Appl. No.: 18/981,280

(22) Filed: Dec. 13, 2024

(51) Int. Cl. G06Q 30/0601; G06Q 10/087

(52) U.S. Cl. CPC G06Q 30/0631; G06Q 10/087

(57) ABSTRACT

An online system receives, from a computing device associated with a servicing user, an indication that items are collected for an order. The system identifies a runover by determining that a total value of the items collected for the order is greater than an expected value of the order. The system performs runover verification by: identifying features from the order, the items collected, and the runover, applying a remediation time prediction model to the features to predict an amount of time to remediate the runover, applying an uplift model to the features to predict a differential loss between a loss associated with rejecting the runover and a loss associated with verifying the runover, and verifying or rejecting the runover based on the predicted amount of time to remediate and the predicted differential loss. The online system transmits a notification indicating the verification results.

### BACKGROUND

An online system hosts an online platform that receives orders from users and matches those orders to pickers for fulfillment. Fulfillment of an order involves obtaining a list of items from one or more source locations and delivering the items to a delivery location associated with the ordering user. When a picker seeks to finalize an order at a source location (e.g., at checkout), the picker requests verification of the actual items obtained against the order provided by the user. In certain instances, the picker may have a runover in fulfilling the order, resulting in a total value exceeding the anticipated value when the order was placed. However, remediating the runover can be resource intensive, creating a challenge in determining which runovers to remediate. Moreover, runovers directly impact fulfillment accuracy and ordering reliability, e.g., when a user orders one thing but the picker obtains something different. The decision about whether to approve or deny transactions with a runover is thus complicated.

### SUMMARY

In accordance with one or more aspects of the disclosure, an online system performs runover verification to minimize waste of resources and optimize one or more metrics. In one or more embodiments, the online system receives, from a computing device associated with a servicing user, an indication that items are collected for an order (e.g., in connection with a check-out event at a point of sale terminal at a source location). The system detects a runover by determining that a total value of the items collected for the order is greater than an expected value of the order. In response, the system performs runover verification by identifying features from the order, the items collected, and the runover; applying a remediation time prediction model to the features to predict an amount of time to remediate the runover; applying an uplift model to the features to predict a differential loss between a loss associated with rejecting the runover and a loss associated with verifying the runover; and verifying or rejecting the runover based on the predicted amount of time to remediate and the predicted differential loss. The online system transmits a notification indicating the verification results. If verified, the online system may progress the order to completion, e.g., transmitting delivery instructions to the servicing user. If rejected, the online system may indicate remedial instructions for replacing one or more of the items collected.

Leveraging the uplift model in conjunction with the remediation time prediction model identifies the pathway that saves resources. This is an improvement over conventional systems categorically rejecting all runovers, which may actually result in more wasted resources.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an example flowchart of validating finalization requests received from a picker client device with a remediation time prediction model and an uplift model, in accordance with one or more embodiments.

FIG. 4 illustrates a method flowchart of the verification process leveraging an uplift model, in accordance with one or more embodiments.

### DETAILED DESCRIPTION

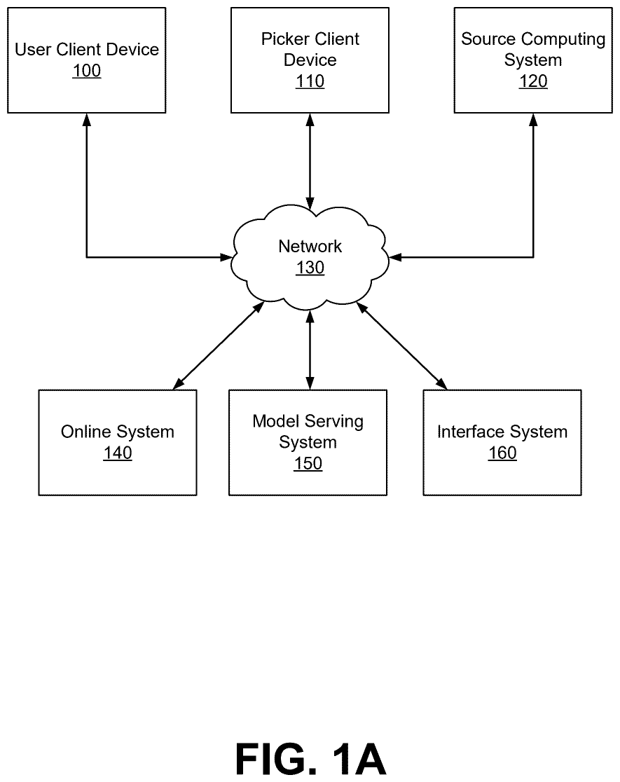

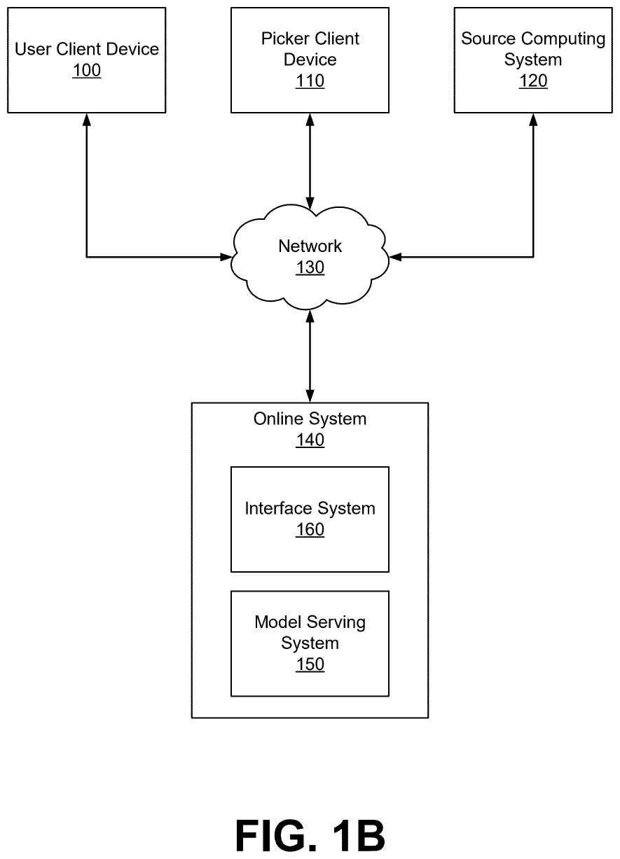

FIG. 1A illustrates an example system environment for an online system 140, in accordance with one or more embodiments. The system environment illustrated in FIG. 1A includes a user client device 100, a picker client device 110, a source computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 can view orders presented by the online system 140 for the picker to select for servicing. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order from a source location, the picker client device 110 sends a verification request to the online system 140 to validate the finalization of the order, i.e., prior to delivery of the order to the user. The online system 140 evaluates whether the total value of the items collected is within a range of the expected total value. If the total value is over the expected range, the online system 140 applies a remediation time prediction model to predict a time to remediate the order assuming the verification request is rejected and an uplift model to predict a differential loss between verifying the verification request and rejecting the verification request. The online system 140 may determine whether to approve or to reject the verification request based on the predicted remediation time and the predicted differential loss. If approved, the online system 140 progresses the picker to next steps with fulfillment of the order. If rejected, the online system 140 may generate and transmit a notification to the picker client device 110 with instructions to remediate the order, prior to progressing to the next steps.

Upon verification from the online system 140, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

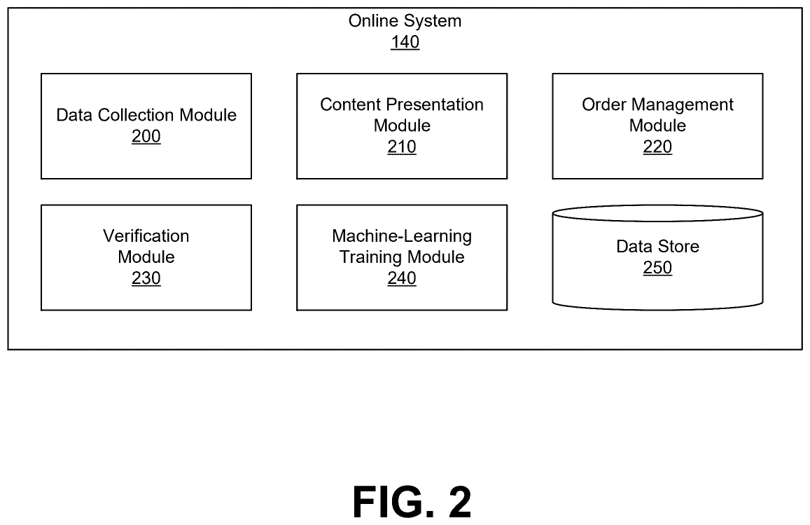

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 or the interface system 160 is managed by a separate entity from the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a verification module 230, a machine-learning training module 240, and a data store 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 250. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 250.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. At such time, the order management module 220 may transmit the indication to the verification module 230 to validate finalizing of the order, in order to progress to delivery of the order.

When the order management module 220 receives verification from the verification module 230 to proceed with delivery of the order, the order management module 220 may transmit next steps in the completion of the order. For example, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

If the order management module 220 receives a rejection from the verification module 230, the order management module 220 may initiate a remedial workflow to remediate the rejected order. The order management module 220 analyzes the collected items compared to the order request by the user. The order management module 220 may identify one or more of the items collected contributing to the runover. For example, the order management module 220 may identify that the picker selected an incorrect count of an item (e.g., 5 count instead of 2 count). Or, in another example, the order management module 220 identifies that the picker selected the wrong brand of an item (e.g., a more expensive brand compared to a more generic brand). In yet another example, the order management module 220 identifies that the picker obtained too much of one type of item (e.g., 2 units of weight compared to a requested 1 unit of weight). The order management module 220 may generate remedial instructions for the picker based on the identified items contributing to the runover. In some embodiments, the order management module 220 may leverage an agent (e.g., human or artificial intelligence) to initiate communications with the picker to address the runover.

The verification module 230 validates whether items in the order have been collected accurately. The verification module 230 receives a verification request from the order management module 220, i.e., triggered by an indication from the picker client device 110, that the picker has obtained all items in an order. The verification module 230 receives the verification request and obtains order data and other contextual data relating to the order (e.g., of the source location, of the picker, of the user, etc.). The verification module 230 compares a total value of the items collected to an expected value of the order.

In one or more embodiments, if the total value is above the expected value, the verification module 230 may leverage a remediation time prediction model and an uplift model to determine whether to approve or to reject the verification request. The remediation time prediction model is configured to determine, based on the order data and/or other contextual data, a predicted remediation time indicating a predicted amount of time to remediate the order if the verification request is rejected. The uplift model is configured to determine, based on the order data and/or other contextual data, a differential loss between rejecting the verification request and verifying the verification request.

Based on the predicted differential loss and the predicted remediation time, the verification module 230 determines whether to approve or to reject the verification request. In one or more embodiments, the verification module 230 may leverage a conversion parameter to convert the predicted time into the loss metric or to convert the differential loss into the time metric. Upon transformation, the verification module 230 may compare the two predictions to determine the action that optimally saves on resources.

In some embodiments, if the predicted remediation time is larger than the differential loss, then the verification module 230 approves the verification request, and, conversely, if the differential loss is larger than the predicted remediation time, then the verification module 230 rejects the request.

In some embodiments, the verification module 230 may leverage a ratio or some multiplicative factor for comparing the predicted remediation time and the predicted differential loss. For example, if rejecting the action is predicted to result in a high amount of time to remediate compared to a minimal differential loss between rejecting and verifying (e.g., 1.5× and above, 2× and above, 3× and above, or 4× and above), then the verification module 230 approves the verification request. If, on the contrary, rejecting the action is predicted to result in a minimal amount of time to remediate compared to a high differential loss between rejecting and verifying (e.g., 1.5× and above, 2× and above, 3× and above, or 4× and above), then the verification module 230 rejects the request. And, if otherwise, i.e., the two predictions are within a threshold distance from each other, then the verification module 230 may leverage another normalcy model for these “close calls.” The other normalcy model may input the order data and/or any other contextual features to predict a likelihood that the runover is within bounds of normalcy, e.g., within a 90% confidence interval of normalcy, to determine whether to approve or to reject the verification request. If the normalcy model determines that the runover is within the bounds of normalcy, then the verification module 230 approves the verification request, and, conversely, if the normalcy model determines that the runover is beyond the bounds of normalcy, i.e., “anomalous,” then the verification module 230 rejects the verification request.

The machine-learning training module 240 trains machine-learning models used by the online system 140. For example, the machine learning module 230 may train the item selection model, the availability model, or any of the machine-learned models deployed by the model serving system 150. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 240 generates the set of parameters (e.g., the particular values of the parameters) for a machine-learning model by “training” the machine-learning model. Once trained, the machine-learning model uses the set of parameters to transform inputs into outputs.

The machine-learning training module 240 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 240 may apply an iterative process to train a machine-learning model whereby the machine-learning training module 240 updates parameter values of the machine-learning model based on each of the set of training examples. The training examples may be processed together, individually, or in batches. To train a machine-learning model based on a training example, the machine-learning training module 240 applies the machine-learning model to the input data in the training example to generate an output based on a current set of parameter values. The machine-learning training module 240 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 240 updates the set of parameters for the machine-learning model based on the score generated by the loss function. For example, the machine-learning training module 240 may apply gradient descent to update the set of parameters.

In some embodiments, the machine-learning training module 240 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 240 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 250 stores data used by the online system 140. For example, the data store 250 stores user data, item data, order data, and picker data for use by the online system 140. The data store 250 also stores trained machine-learning models trained by the machine-learning training module 240. For example, the data store 250 may store the set of parameters for a trained machine-learning model on one or more non-transitory, computer-readable media. The data store 250 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 240 may further train parameters of the machine-learned model based on data specific to the online system 140 stored in the data store 250. As an example, the machine-learning training module 240 may obtain a pre-trained transformer language model and further fine tune the parameters of the transformer model using training data stored in the data store 250. The machine-learning training module 240 may provide the model to the model serving system 150 for deployment.

### Verification of a Collected Order With an Uplift Model

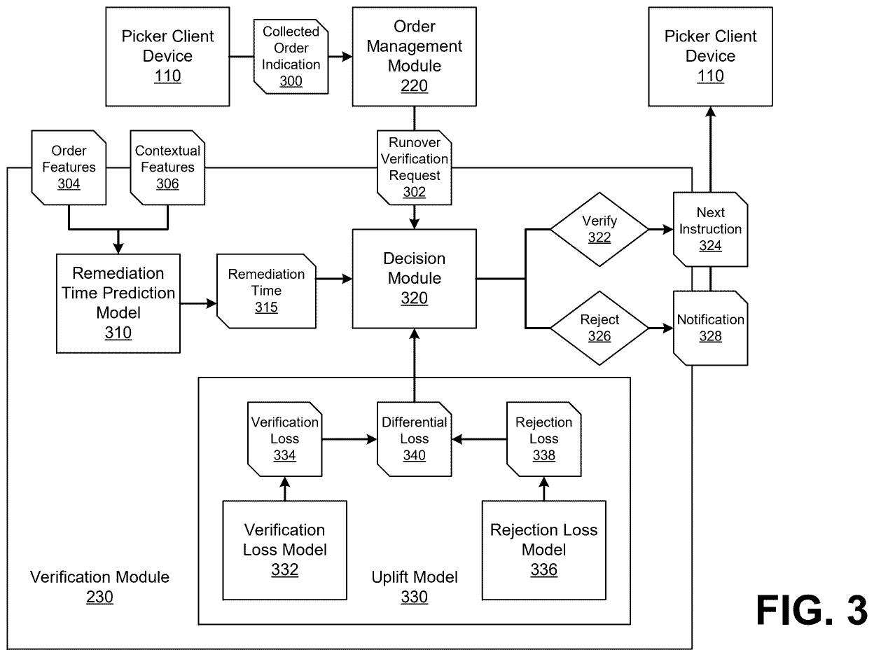

FIG. 3 illustrates an example flowchart of validating finalization requests received from a picker client device with a remediation time prediction model and an uplift model, in accordance with one or more embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

The picker client device 110 provides an indication 300 of a collected order to the online system 140. In some embodiments, the picker is at a payment terminal, intending to purchase the items collected for an order from a source location. The picker may provide payment to the source location via an account with funds managed by the online system 140. The payment terminal provides the payment request to the online system 140, which then prompts the online system 140 to validate whether to approve or to reject input of funds into the account, e.g., to be transferred to the source location. In other embodiments, the picker client device 110 provides indication to the online system 140 that all items in an order are collected, and the online system 140 receives that indication.

Prior to progressing to delivery, the online system 140 approves of the collected order. If the total value of the collected order is below the expected value, the online system 140 approves the collected order. If the total value of the collected order is above the expected value, the online system 140 approves the collected order, i.e., progressing the order to next steps towards completion. If, however, the total value of the collected order is above the expected value, i.e., a runover, the online system 140 performs verification of the runover. The order management module 220 may provide a runover verification request 302 to the verification module 230, whether to approve or to reject the collected order.

Upon receipt of a runover verification request 302, the verification module 230 leverages a remediation time prediction model 310 to predict a remediation time 315 for remediation of the collected order and an uplift model 330 to predict a differential loss indicating the difference in loss of resources between rejecting and verifying the runover, both of which are leveraged to determine whether to approve 322 or to reject 326 the collected order.

The remediation time prediction model 310 is configured to input order features 304 and, optionally, contextual features 306 to output the predicted remediation time 315. The remediation time prediction model 310 may be a machine-learning model trained on historical sessions of pickers remediating rejected orders. In one or more embodiments, the machine-learning training module 240 may generate the training dataset by gathering sessions where a collected order that had a runover compared to the expected value was rejected by the online system 140. The rejection is conveyed to the picker client device 110. The picker remediates the collected order to achieve the verification. The data collection module 200 may track the time to remediate the initially rejected order. Once approved, the data collection module 200 may log a total time to remediate. The machine-learning training module 240 may perform supervised training of the remediation time prediction model 310 based on these historical sessions with actual remediation time spent by pickers to remediate the rejected orders. To perform the training, the machine-learning training module 240 may extract features from the rejected order to generate a feature vector. The machine-learning training module 240 may feed the feature vectors of the training dataset, while adjusting parameters of the remediation time prediction model 310 against an error measured between the predictions and the actual remediation times. As the remediation time prediction model 310 is deployed, the data collection module 200 may gather additional training data from novel sessions of a picker remediating a rejected order. The machine-learning training module 240 may fine tune (i.e., retrain) the remediation time prediction model 310 based on the additional training data.

The uplift model 330 is configured to input order features 304 and/or the contextual features 306 to output the predicted differential loss 340. In some embodiments, the uplift model 330 may input, as a component of the order features 304, the runover for the collected order 300. The uplift model 330 may be a machine-learning model configured to input the order features 304 and/or the contextual features 306 to output the predicted differential loss 340, which represents a difference between a first loss of resources to the online system 140 associated with the rejection of a runover and a second loss of resources to the online system 140 associated with the verification of a runover.

In some embodiments, the uplift model 330 is architected with two submodels: a rejection loss model 332 and a verification loss model 336. The rejection loss model 332 is trained to predict, based on the order features 304 and/or the contextual features 306, a rejection loss 334 attributable to rejecting the order. The rejection loss 334 is a measure of loss of resources to the online system 140, e.g., based on a loss in order fulfillment efficiency due to remediating the rejected order. To train the rejection loss model 332, the data collection module 200 may track impact on the order fulfillment workflow due to the rejection. The machine-learning training module 240 may leverage a function to calculate the loss based on the tracked impact. The machine-learning training module 240 may extract features from the rejected order to generate a feature vector. The machine-learning training module 240 may feed the feature vectors of the training dataset, while adjusting parameters of the rejection loss model 332 against an error measured between the predictions and the actual rejection losses.

The verification loss model 336 is trained to predict, based on the order features 304 and/or the contextual features 306, a verification loss 338 attributable to verifying the order. The verification loss 338 is a measure of loss of resources to the online system 140, e.g., based on a loss from the online system remunerating the user to some extent for the runover. To train the verification loss model 336, the data collection module 200 may track lost resources due to approved runovers. In some embodiments, if the runover is within reason, the online system 140 may pass the runover to the user, requesting the total value (inclusive of the runover). The machine-learning training module 240 may extract features from the approved order to generate a feature vector. The machine-learning training module 240 may feed the feature vectors of the training dataset, while adjusting parameters of the verification loss model 336 against an error measured between the predictions and the actual verification losses.

In some embodiments, the uplift model 330 computes the differential loss 340 as a difference between the rejection loss 334 and the verification loss 338. For example, the verification loss 338 is subtracted from the rejection loss 334. For example, with some runovers predicted to have a positive rejection loss 334 and a positive verification loss 338, the differential loss 340 provides a relative metric to understand the degree the rejection is more costly than the verification. If the two losses are close, then the differential loss 340 would be small. In one or more embodiments, if the verification loss 338 is greater than the rejection loss 334, i.e., the differential loss 340 is negative, then the decision module 320 rejects the runover verification request 302.

The decision module 320 evaluates the differential loss 340 and the remediation time 315 to determine whether to approve 322 or to reject 326 the runover request. In some embodiments, the decision module 320 may leverage heuristics that weigh the remediation time 315 and the differential loss 340 to determine the verification action: to approve 322 or to reject 326. In some embodiments, the heuristics dictate that if the predicted remediation time 315 is larger than the differential loss 340, then the decision module 320 approves 322 the verification request, and, conversely, if the differential loss 340 is larger than the predicted remediation time 315, then the decision module 320 rejects 326 the request. In some embodiments, the decision module 320 may leverage a ratio or some multiplicative factor for comparing the predicted remediation time 315 and the predicted differential loss 340. And, if the two predictions are within a threshold distance from each other, then the decision module 320 may leverage another normalcy model for these “close calls.” The other normalcy model may input the order data and/or any other contextual features to predict a likelihood that the runover is within bounds of normalcy, to determine whether to approve or to reject the verification request. If the normalcy model determines that the runover is within the bounds of normalcy, then the decision module 320 approves the verification request, and, conversely, if the normalcy model determines that the runover is beyond the bounds of normalcy, i.e., “anomalous,” then the decision module 320 rejects the verification request. Additional information relating to the normalcy model for predicting whether the runover is within the bounds of normalcy is further described in U.S. application Ser. No. 18/213,756, filed on Jun. 23, 2023, which is hereby incorporated by reference in its entirety.

The verification 322 or the rejection 326 triggers follow-on actions. The verification 322 progresses the collected order to completion. In some embodiments, the progression may entail providing a next instruction 324 to the picker client device 110 to complete the order. The next instruction 324 may be delivery instructions. In some embodiments, the verification 322 may result in permitting the payment of the collected order, e.g., via an account funded by the online system 140. The next instructions 324 is transmitted to the picker client device 110, and may be part of a notification indicating that the runover is approved. The rejection 326 triggers a remedial workflow. In some embodiments, the remedial workflow includes generating a notification 328 to the picker client device 110 of the rejection. The notification 328 may further specify remedial instructions to remediate the collected order. The verification module 230 may provide the verification 322 or the rejection 326 to the order management module 220 for further actions relating to the verification 322 or the rejection 326.

### Example Methods

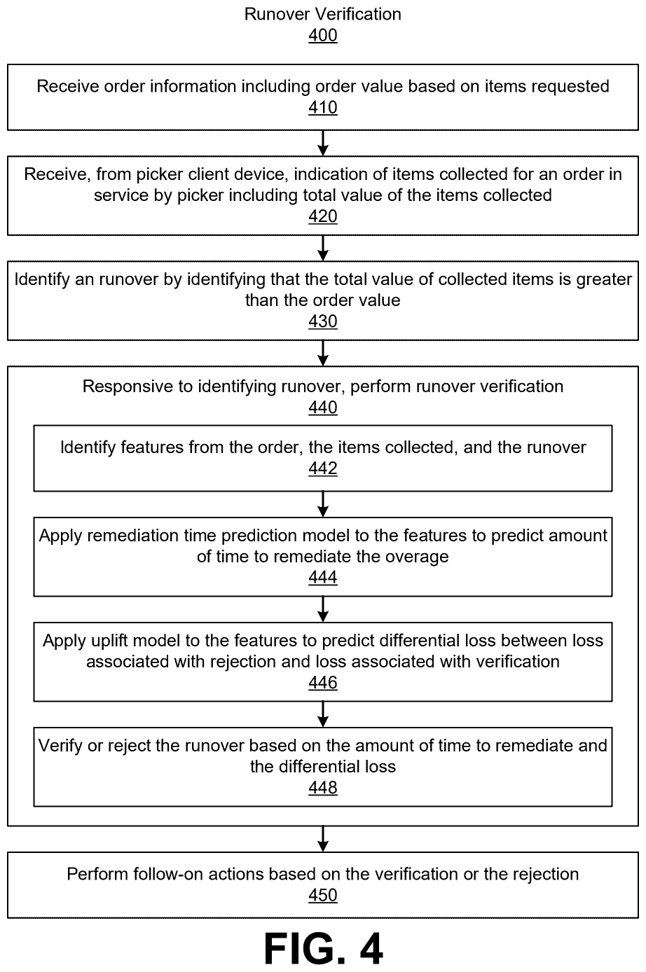

FIG. 4 illustrates a method flowchart of the verification process leveraging an uplift model, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system receives 410 order information including an order value based on items requested in the order. The order may be received from a user, e.g., via their client device. The order may indicate items requested by the user to be obtained and, optionally, delivered to the user. The order value is an estimate based on the requested items. In some embodiments, compensation for the order value is collected from the user and by the online system prior to servicing the order.

The online system receives 420, from a computing device associated with a servicing user, an indication that items are collected for an order, the indication also including a total value of the actual items collected. As the picker is servicing the order, the picker obtains the physical items from the source location. Prior to completion of the order, the picker indicates to the online system that the items requested in the order have now been physically obtained. The indication total value is based on the actually obtained items. For example, the order submitted by the user may have indicated a general metric of a requested item (e.g., one pound). The picker may obtain the actual item, which differs in the requested metric (e.g., 1.25 pounds). The total value may sum up the actually realized values of the collected items.

The online system identifies 430 a runover by identifying that the total value of the items collected for the order is greater than the order value. In some embodiments, the runover is identified if the total value is greater than the order value. In other embodiments, the runover is identified if the total value is greater than the order value, accounting for some tolerance.

The online system performs 440 runover verification. To perform the verification, the online system identifies 442 features from the order, the items collected, and the runover. The online system applies 444 a remediation time prediction model to the features to predict an amount of time to remediate the runover. The remediation time prediction model is trained as a machine-learning model on historical orders that were rejected due to runover with the remediation time tracked. The online system applies 446 an uplift model to the features to predict a differential loss between a loss associated with rejecting the runover and a loss associated with verifying the runover. The online system verifies or rejects 448 the runover based on the predicted amount of time to remediate and the predicted differential loss. The rejection loss model and the verification loss model are trained as machine-learning models with historical orders rejecting runover orders or verifying runover orders, respectively.

The online system transmits 450 a notification indicating the verification results. If the runover is verified, the online system may generate the notification with next instructions for completing the order, e.g., delivery, etc. If the runover is rejected, the online system may generate the notification to include remedial instructions for replacing one or more of the items collected, so as to reduce the runover. In such embodiments, the online system may identify which of the collected items contributed to the runover compared to the corresponding requested item in the order. Following verification or rejection, the online system may track actions by the picker to complete the order. Once the order is completed, the online system may assess and compute the actual loss for the runover order. Based on the actual loss, the online system may finetune (i.e., retrain) the uplift model. If the runover was rejected, the online system may also track the remediation time to remediate the order unto completion. The online system may finetune (i.e., retrain) the remediation time prediction model based on the actual time taken to remediate the runover order that was rejected.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving information of an order in service by a user including an order value based on one or more items requested in the order;
receiving, from a computing device of the user, an indication that items are collected for the order in service by the user, the indication further including a total value of the items collected;
identifying a runover by identifying that the total value of the items collected for the order is greater than the order value;
responsive to identifying the runover, performing a runover verification process comprising:
identifying features from the order, the items collected, and the runover,
applying a remediation time prediction model to the features to predict an amount of time to remediate the runover by replacing one or more of the items collected,
applying an uplift model to the features to predict a differential loss as a difference between a loss associated with rejecting the runover and a loss associated with verifying the runover, and
verifying or rejecting the runover based on the predicted amount of time to remediate and the predicted differential loss; and
transmitting, to the computing device, a notification indicating verification or rejection of the runover.

2. The method of claim 1, further comprising:
responsive to verifying the runover, generating the notification to further include one or more next instructions for completion of the order.

3. The method of claim 1, further comprising:
responsive to rejecting the runover, generating the notification to further include one or more remedial instructions for replacing one or more of the items collected.

4. The method of claim 3, further comprising, responsive to rejecting the runover:
identifying, for each item collected, an item runover as a difference between a value of the item collected and an expected value of a corresponding item in the order; and
identifying the one or more of the items to be replaced based on the item runovers.

5. The method of claim 4, further comprising:
obtaining values of items in the order from an item database; and
identifying the expected value of the order based on the values of items in the order.

6. The method of claim 1, wherein the remediation time prediction model is trained by a process comprising:
obtaining historical orders serviced by other users and rejected due to runover, wherein each of the historical orders further indicates an amount of time spent by the user in remediation of historical order;
identifying features of the historical orders; and
training the remediation time prediction model as a machine-learning model with the features of the historical orders and the amounts of time spent by the other users in remediation of the historical orders.

7. The method of claim 1, wherein applying the uplift model comprises:
applying a rejection loss model to the features to predict the loss associated with rejecting the runover; and
applying a verification loss model to the features to predict the loss associated with verifying the runover.

8. The method of claim 7, wherein the uplift model is trained by a process comprising:
obtaining historical orders with runover and serviced by other users, wherein each of the historical orders further indicates a loss associated with the runover;
identifying features of the historical orders;
identifying a first subset of the historical orders with the runover rejected and a second subset of the historical orders with the runover verified;
training the rejection loss model as a machine-learning model with the features of the first subset of the historical orders and corresponding losses of the first subset of the historical orders; and
training the verification loss model as a machine-learning model with the features of the second subset of the historical orders and the corresponding losses of the second subset of the historical orders.

9. The method of claim 1, wherein verifying or rejecting the runover based on the predicted amount of time to remediate and the differential loss comprises:
applying a conversion parameter to the predicted amount of time to remediate to transform the predicted amount of time into a loss metric;
verifying the runover responsive to identifying that the transformed amount of time to remediate is greater than the predicted differential loss; and
rejecting the runover responsive to identifying that the predicted differential loss is greater than the transformed amount of time to remediate.

10. The method of claim 1, wherein verifying or rejecting the runover based on the predicted amount of time to remediate and the differential loss comprises:
applying a conversion parameter to the predicted amount of time to remediate to transform the predicted amount of time into a loss metric;
identifying that a distance between the transformed amount of time to remediate and the predicted differential loss is within a threshold;
responsive to identifying that the distance is within the threshold, applying a normalcy model to the features from the order, the items collected, and the runover to predict whether the runover is normal or anomalous;
verifying the runover responsive to predicting the runover to be normal; and
rejecting the runover responsive to predicting the runover to be anomalous.

11. The method of claim 1, further comprising:
tracking completion of the order following the notification indicating the verification or the rejection of the runover;
identifying an actual loss associated with the runover for the order based on the completion of the order; and
retraining the uplift model based on the loss associated with the runover for the order.

12. A non-transitory computer-readable storage medium storing instructions that, when executed by a processor, cause the processor to perform operations comprising:
receiving information of an order in service by a user including an order value based on one or more items requested in the order;
receiving, from a computing device of the user, an indication that items are collected for the order in service by the user, the indication further including a total value of the items collected;
identifying a runover by identifying that the total value of the items collected for the order is greater than the order value;
responsive to identifying the runover, performing a runover verification process comprising:
identifying features from the order, the items collected, and the runover,
applying a remediation time prediction model to the features to predict an amount of time to remediate the runover by replacing one or more of the items collected,
applying an uplift model to the features to predict a differential loss as a difference between a loss associated with rejecting the runover and a loss associated with verifying the runover, and
verifying or rejecting the runover based on the predicted amount of time to remediate and the predicted differential loss; and
transmitting, to the computing device, a notification indicating verification or rejection of the runover.

13. The non-transitory computer-readable storage medium of claim 12, the operations further comprising:
responsive to verifying the runover, generating the notification to further include one or more next instructions for completion of the order; or
responsive to rejecting the runover, generating the notification to further include one or more remedial instructions for replacing one or more of the items collected.

14. The non-transitory computer-readable storage medium of claim 13, the operations further comprising, responsive to rejecting the runover:
identifying, for each item collected, an item runover as a difference between a value of the item collected and an expected value of a corresponding item in the order; and
identifying the one or more of the items to be replaced based on the item runovers.

15. The non-transitory computer-readable storage medium of claim 12, wherein the remediation time prediction model is trained by a process comprising:
obtaining historical orders serviced by other users and rejected due to runover, wherein each of the historical orders further indicates an amount of time spent by the user in remediation of historical order;
identifying features of the historical orders; and
training the remediation time prediction model as a machine-learning model with the features of the historical orders and the amounts of time spent by the other users in remediation of the historical orders.

16. The non-transitory computer-readable storage medium of claim 12, wherein applying the uplift model comprises:
applying a rejection loss model to the features to predict the loss associated with rejecting the runover; and
applying a verification loss model to the features to predict the loss associated with verifying the runover.

17. The non-transitory computer-readable storage medium of claim 16, wherein the uplift model is trained by a process comprising:
obtaining historical orders with runover and serviced by other users, wherein each of the historical orders further indicates a loss associated with the runover;
identifying features of the historical orders;
identifying a first subset of the historical orders with the runover rejected and a second subset of the historical orders with the runover verified;
training the rejection loss model as a machine-learning model with the features of the first subset of the historical orders and corresponding losses of the first subset of the historical orders; and
training the verification loss model as a machine-learning model with the features of the second subset of the historical orders and the corresponding losses of the second subset of the historical orders.

18. The non-transitory computer-readable storage medium of claim 12, wherein verifying or rejecting the runover based on the predicted amount of time to remediate and the differential loss comprises:
applying a conversion parameter to the predicted amount of time to remediate to transform the predicted amount of time into a loss metric;
verifying the runover responsive to identifying that the transformed amount of time to remediate is greater than the predicted differential loss; and
rejecting the runover responsive to identifying that the predicted differential loss is greater than the transformed amount of time to remediate.

19. The non-transitory computer-readable storage medium of claim 12, the operations further comprising:
tracking completion of the order following the notification indicating the verification or the rejection of the runover;
identifying an actual loss associated with the runover for the order based on the completion of the order; and
retraining the uplift model based on the loss associated with the runover for the order.

20. A system comprising
a processor; and
a non-transitory computer-readable storage medium storing instructions that, when executed by the processor, cause the processor to perform operations comprising:
receiving information of an order in service by a user including an order value based on one or more items requested in the order;
receiving, from a computing device of the user, an indication that items are collected for the order in service by the user, the indication further including a total value of the items collected;
identifying a runover by identifying that the total value of the items collected for the order is greater than the order value;
responsive to identifying the runover, performing a runover verification process comprising:
identifying features from the order, the items collected, and the runover,
applying a remediation time prediction model to the features to predict an amount of time to remediate the runover by replacing one or more of the items collected,
applying an uplift model to the features to predict a differential loss as a difference between a loss associated with rejecting the runover and a loss associated with verifying the runover, and
verifying or rejecting the runover based on the predicted amount of time to remediate and the predicted differential loss; and
transmitting, to the computing device, a notification indicating verification or rejection of the runover.
